(19) United States
(12) Patent Application Publication
(10) Pub. No.: US 2026/0061692 A1
(43) Pub. Date: Mar. 5, 2026

(54) METHOD FOR OBTAINING GOOD ADHESION OF SEMI CRYSTALLINE POLYMERS TO THE BUILD PLATE DURING FDM PRINTING

(71) Applicant: SIGNIFY HOLDING B.V., EINDHOVEN (NL)

(72) Inventors: RIFAT ATA MUSTAFA HIKMET, EINDHOVEN (NL); TIES VAN BOMMEL, HORST (NL)

(21) Appl. No.: 19/104,562

(22) PCT Filed: Aug. 8, 2023
(86) PCT No.: PCT/EP2023/071888

§ 371 Date: Feb. 18, 2025

(30) Foreign Application Priority Data
Aug. 18, 2022 (EP) 22190970.8

(51) Int. Cl. B29C 64/118; B29C 64/245; B29C 64/295; B29C 64/393; B33Y 10/00; B33Y 30/00; B33Y 50/02

(52) U.S. Cl. CPC B29C 64/118; B29C 64/245; B29C 64/295; B29C 64/393; B33Y 10/00; B33Y 30/00; B33Y 50/02

(57) ABSTRACT

A method for producing a 3D item (1) by means of fused deposition modelling of 3D printed material (202) on a receiver item (550), wherein the 3D item (1) comprises a plurality of layers (322) of 3D printed material (202); wherein: (a) the printable material (201) comprises a semi-crystalline polymer; (b) the 3D printable material (201) has (i) a melting temperature range, ranging from a first melting temperature T_{M1} to a second melting temperature T_{M2}, wherein T_{M2}>T_{M1}, and (ii) a crystallization temperature range, ranging from a second crystallization temperature Tc₂ to a first crystallization temperature Tci, wherein T_{C2}>T_{C1}; (c) the 3D printing stage comprises guiding the 3D printable material (201) through a printer nozzle (502) at a nozzle temperature T_{N}; wherein T_{N}>T_{M2}; (d) the method comprises during a first sub-stage of the 3D printing stage: depositing 3D printable material (201) on the receiver item (550) having a first receiver item temperature T_{B1}, to provide n₁ first layers (1322) on the receiver item (550); wherein T_{B1}>T_{M2}; (e) the method comprises during a second sub-stage of the 3D printing stage: cooling n₁₂ first layers of the n₁ first layers (1322) and selecting a second receiver item temperature T_{B2} of the receiver item (550), wherein T_{N2}<T_{B1}; and (f) the method comprises during a third sub-stage of the 3D printing stage: depositing 3D printable material (201) on the previously deposited n₁ first layers (1322), to provide n₂ second layers (2322) thereon.

### FIELD OF THE INVENTION

The invention relates to a method for manufacturing a 3D (printed) item. The invention also relates to the 3D (printed) item obtainable with such method. Further, the invention relates to a lighting device including such 3D (printed) item. Yet further, the invention may also relate to a 3D printer, such as for use in such method.

### BACKGROUND OF THE INVENTION

Methods for improving adhesion during FDM printing are known in the art. US2019106569A1, for instance, describes a polymeric material that includes a semi-crystalline polymer and a secondary material wherein when the secondary material is combined with the semi-crystalline polymer to form a blend having at least a 3° C. reduction in a hot crystallization temperature relative to the neat semi-crystalline polymer.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals, and polymers.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers on a receiver item; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

It appears desirable to produce items from thermoplastic material comprising a semi-crystalline polymer. However, the thermoplastic material comprising the semi-crystalline polymer may collapse or detach from the receiver item during printing. In both cases, the printing cannot proceed and/or an inferior 3D printed item may be obtained. Therefore, it may be difficult to produce 3D printed items from semi-crystalline polymers using existing printing settings.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

In a first aspect the invention provides a method for producing a 3D item by means of fused deposition modelling. Especially, the method may comprise a 3D printing stage comprising layer-wise depositing an extrudate comprising 3D printable material, to provide the 3D item comprising 3D printed material on a receiver item. The 3D item may in embodiments comprise a plurality of layers of 3D printed material. The printable material may especially comprise a semi-crystalline polymer. The 3D printable material may especially have a melting temperature range, ranging from a first melting temperature T_{M1} to a second melting temperature T_{M2}. In embodiments, T_{M2}>T_{M1}. In further embodiments, the 3D printable material may have a crystallization temperature range, ranging from a second crystallization temperature T_{C2} to a first crystallization temperature T_{C1}. In embodiments, T_{C2}>T_{C1}. In embodiments, the 3D printing stage may comprise guiding the 3D printable material through a printer nozzle at a nozzle temperature T_{N}. In specific embodiments, T_{N}>T_{M2}. The method may in embodiments comprise during a first sub-stage of the 3D printing stage: depositing 3D printable material on the receiver item to provide n₁ first layers on the receiver item. The receiver item may in embodiments have a first receiver item temperature T_{B1}. In embodiments, T_{B1}≥T_{C1}, especially, T_{B1}≥T_{M1}. In more specific embodiments, T_{B1}≥T_{M2}. Especially, n₁≥1. In embodiments, the method may comprise during a second 3D printing stage of the 3D printing stage: (actively) cooling n₁₂ first layers of the n₁ first layers. In further embodiments, the method may comprise during a second sub-stage of the 3D printing stage: selecting a second receiver item temperature T_{B2} of the receiver item. In embodiments, T_{B2}≤T_{B1}. Especially wherein 1≤n₁₂≤n₁. In yet further embodiments, the method may comprise during a third sub-stage of the 3D printing stage: depositing 3D printable material on the previously deposited n₁ first layers, to provide n₂ second layers thereon. In embodiments, n₂≥1. Hence, in specific embodiments the invention provides a method for producing a 3D item by means of fused deposition modelling, wherein the method comprises a 3D printing stage comprising layer-wise depositing 3D printable material, to provide the 3D item comprising 3D printed material on a receiver item, wherein the 3D item comprises a plurality of layers of 3D printed material; wherein: (a) the printable material comprises a semi-crystalline polymer; (b) the 3D printable material has (i) a melting temperature range, ranging from a first melting temperature T_{M1} to a second melting temperature T_{M2}, wherein T_{M2}>T_{M1}, and (ii) a crystallization temperature range, ranging from a second crystallization temperature T_{C2} to a first crystallization temperature T_{C1}, wherein T_{C2}>T_{C1}; (c) the 3D printing stage comprises guiding the 3D printable material through a printer nozzle (502) at a nozzle temperature T_{N}; wherein T_{N}>T_{M2}; (d) the method comprises during a first sub-stage of the 3D printing stage: depositing 3D printable material on the receiver item having a first receiver item temperature T_{B1}, to provide n₁ first layers on the receiver item; wherein T_{B1}≥T_{M2}; (e) the method comprises during a second sub-stage of the 3D printing stage: cooling n₁₂ first layers of the n₁ first layers and selecting a second receiver item temperature T_{B2} of the receiver item, wherein T_{B2}≤T_{B1}, and one of (i) selecting T_{B2}<T_{M2}, or (ii) the n₁ first layers (1322) comprise a first subset comprising n₁₁ first layers and a second subset comprising the n₁₂ first layers, wherein the first subset of n₁ first layers is in contact with the receiver item, wherein the second subset of n₁₂ first layers is configured on top of the first subset, wherein cooling the n₁₂ first layers comprises actively cooling the second subset comprising the n₁₂ first layers of the n₁ first layers to a temperature below T_{C2} and selecting the second receiver item temperature T_{B2} of the receiver item, wherein T_{B2}>T_{M2}; and (f) the method comprises during a third sub-stage of the 3D printing stage: depositing 3D printable material on the previously deposited n₁ first layers, to provide n₂ second layers thereon.

In this way, 3D printing conditions, especially temperatures, may be tuned to prevent the 3D item from collapsing and/or detaching from the receiver item when the 3D item is being printed. By a dedicated cooling of one or more layers, the 3D printed item may better maintain its structure. Additionally, the printed material that is in contact with the receiver item may especially be kept at least partially melted for adhesion of the 3D item to the receiver item.

As indicated above the invention may provide a method for producing a 3D printed item by guiding the 3D printable material through a printer nozzle at a nozzle temperature T_{N} followed by layer-wise depositing the 3D printable material. The 3D printed item may especially comprise a plurality of layers of 3D printed material. In embodiments, the 3D printable material and hence the 3D printed material may comprise a semi-crystalline polymer. The printable material comprising the semi-crystalline polymer may also be referred to as first printable material. Likewise, the printed material comprising the semi-crystalline polymer may also be referred to as first printed material. Semi-crystalline polymer materials may exhibit regions of organized and tightly packed molecular chains. Such areas of crystallinity may be surrounded by amorphous areas, wherein the molecular chains may be oriented randomly.

The semi-crystalline polymer, and hence the 3D printable material, may have a melting temperature range, ranging from a first melting temperature T_{M1} to a second melting temperature T_{M2}. Herein, especially T_{M2}>T_{M1}. The semi-crystalline polymer, and hence the 3D printable material may have a crystallization temperature range, ranging from a second crystallization temperature T_{C2} to a first crystallization temperature T_{C1}. Herein, especially T_{C2}>T_{C1}.

In embodiments, T_{M2}>T_{C2}, such as T_{M2}−T_{C2}≤200° C., like T_{M2}−T_{C2}≤100° C. In more specific embodiments, T_{M2}−T_{C2}≤75° C., like T_{M2}−T_{C2}≤60° C., such as T_{M2}−T_{C2}≤20° C. In embodiments, T_{M2}−T_{C2}≥5° C., such as at least 10° C. Additionally or alternatively, |T_{M1}−T_{C1}|≤200° C., such as |T_{M1}−T_{C1}|≤100° C. In specific embodiments, |T_{M1}−T_{C1}|≤75° C., such as |T_{M1}−T_{C1}|≤60° C., like |T_{M1}−T_{C1}|≤20° C. In embodiments, T_{M1}−T_{C1}>0° C. In alternative embodiments, T_{M1}−T_{C1}<0° C.

Both the melting temperature range and the crystallization temperature range can be measured using e.g. differential scanning colorimetry. A differential scanning calorimeter (DSC) determines a temperature and a heat flow associated with material transitions as a function of time and temperature. In embodiments, the DSC measures the heat flow during cycles of heating a sample and cooling a sample e.g. at a speed of 0.5-1° C./min. The melting temperature range may be determined by heating a solid polymer. T_{M1} may be defined by the onset of melting (onset of an endothermic peak). T_{M2} may be defined by the lowest temperature at which the material is completely melted (end of the endothermic peak). The crystallization temperature range may be determined by cooling a melted polymer. T_{C2} may be defined by the onset of crystallization (onset of an exothermic peak). T_{C1} may be defined by the lowest temperature at which crystallization takes place (end of exothermic peak). The onset of a peak and the end of a peak may in embodiments be defined by the intersection of a base line of the curve and a straight line through the full width half maximum (FWHM) of the peak having an identical slope to the slope of the curve at the FWHM point.

In embodiments, during the 3D printing stage, T_{N}>T_{M2}, such as T_{N}≥(T_{M2}+15° C.), like T_{N}≥(T_{M2}+25° C.), such as T_{N}≥(T_{M2}+30° C.), especially T_{N}≥(T_{M2}+35° C.). Additionally or alternatively T_{N}≤(T_{M2}+90° C.), like T_{N}≤(T_{M2}+80° C.), such as T_{N}≤(T_{M2}+70°C.). In other embodiments, T_{N}≤(T_{M2}+140° C.), such as T_{N}≤(T_{M2}+120° C.), like T_{N} ≤(T_{M2}+100° C.). However, other embodiments may also be possible, such as T_{N}≥(T_{M2}+160° C.). Especially, in embodiments T_{N}≥(T_{M2}+5° C.), more especially T_{N}≥(T_{M2}+10° C.), such as T_{N}≥(T_{M2}+15° C.). In this way, the printable material may be melted and suitable for extrusion.

The method of the invention may comprise a plurality of sub-stages of 3D printing stage. During a first sub-stage of the 3D printing stage, the method may comprise depositing 3D printable material on the receiver item to provide n₁ first layers on the receiver item. In embodiments, n₁≥1, like n₁≥2, such as n₁≥5. Especially, the receiver item has during this first sub-stage a first receiver item temperature T_{B1}. In embodiments, T_{B1}<T_{N}. In specific embodiments, during the first sub-stage the method may comprise selecting T_{B1}≥T_{C1}, such as T_{B1}≥T_{M1}, like T_{B1}≥T_{C2}. In specific embodiments, T_{B1}≥(T_{M1}+T_{M2})/2 and/or T_{B1}≥(T_{C1}+T_{C2})/2. In this way, the 3D printed material may remain partially melted and adhere to the receiver item. In further embodiments during the first sub-stage the method may comprise selecting T_{B1}≥T_{M2}, such as T_{B1}≥(T_{M2}+5° C.), like T_{B1}≥(T_{M2}+8° C.), especially T_{B1}≥(T_{M2}+10° C.). Additionally or alternatively, during the first sub-stage the method may comprise selecting T_{B1}≤(T_{M2}+25° C.), such as T_{B1}≤(T_{M2}+20° C.), like T_{B1}≤(T_{M2}+20° C.). In specific embodiments, T_{M2}<T_{B1}≤(T_{M2}+20° C.). In this way, the 3D printed material may remain melted and adhere to the receiver item.

In alternative embodiments, T_{B1}<Tm₂, such as T_{B1}<Tm₁, like T_{B1}<Tc2. In specific embodiments T_{C1}<T_{B1}<Tc₂, this may especially be relevant for (very) slowly crystallizing polymers.

During a second sub-stage of the 3D printing stage, the method may comprise cooling n₁₂ first layers of the n₁ first layers. In further embodiments of the second sub-stage, the method comprises selecting a second receiver item temperature T_{B2} of the receiver item, especially wherein T_{B2}≤T_{B1}. In specific embodiments, 1≤n₁₂≤n₁. Cooling the n₁₂ first layers may in embodiments be achieved by lowering the receiver item temperature, thus in embodiments T_{B2}<T_{B1}. In alternative embodiments, T_{B2}=T_{B1} and the n₁₂ first layers may be actively cooled by a cooling device, such as a blower or fan. Further embodiments on active cooling will be described below.

In embodiments, T_{N} may be selected from the range of 150-450° C., such as from the range of 190-350° C., like from the range of 200-300° C. In embodiments, T_{B1} may be selected from the range of 100-300° C., such as from the range of 150-250° C. T_{B2} may in embodiments be selected from the range of 75-300° C., such as from the range of 100-250° C., like from the range of 130-200° C. In alternative embodiments, T_{B2} may be selected from the range of 75-150° C., such as from the range of 80-180° C., like from the range of 80-150° C. However, other values may also be possible.

During a third sub-stage of the 3D printing stage, the method may comprise depositing 3D printable material on the previously deposited n₁ first layers, to provide n₂ second layers thereon. Especially, wherein n₂≥1, such as n₂≥3, like n₂≥5, such as n₂≥10. Essentially, the third sub-stage of the 3D printing stage is a “standard” 3D printing stage, except that it was preceded by the first sub-stage and the second sub-stage.

The second sub-stage may in embodiments be subsequent to the first 3D printing stage. The second sub-stage may especially be subsequent to the first layer deposition of the first 3D printing stage. The third sub-stage may in embodiments fully coincide with the second 3D printing stage. In alternative embodiments, the third sub-stage may partially coincide with the second 3D printing stage. In yet alternative embodiments, the third sub-stage may be subsequent to the second 3D printing stage. The first sub-stage and second sub-stage may especially provide layers providing structural and adhesive properties for enabling printing the (remainder of) the 3D item in the third sub-stage.

Especially, the second sub-stage may comprise three (alternative) embodiments. In first embodiments, the second sub-stage may comprise cooling one or more bottom layers of the 3D item by lowering the receiver item temperature. In second embodiments, the second sub-stage may comprise (actively) cooling one or more layers further away from the receiver item. Especially, the receiver item temperature may not be lowered in such embodiments. In third embodiments, the 3D printable material (and hence 3D printed material) may comprise a second 3D printable (and printed) material. In such embodiments, the second sub-stage may comprise cooling one or more bottom layers of the 3D item by lowering the receiver item temperature. Below, more detailed embodiments of these three embodiments are described.

In embodiments, cooling the n₁₂ first layers of the n₁ first layers may be achieved by lowering the receiver item temperature. Thus, during the second sub-stage, the method may in embodiments comprise selecting T_{B2}<T_{B1}. In specific embodiments, T_{B2} may be selected from the range of T_{C1}<T_{B2}<T_{M2}. In alternative embodiments, T_{B2}<T_{C1}. Hence, in specific embodiments, the method comprises selecting during the second sub-stage T_{C1}<T_{B2}<T_{M2}. By cooling the receiver item below T_{M2}, the 3D printed material may become more viscous and may provide some rigidity to the 3D item. By keeping the second receiver item temperature T_{B2} above T_{C1}, the 3D printed material may remain partially melted and may remain adhered to the receiver item. In specific embodiments, T_{B2} may be selected from the range of T_{C1}≤T_{B2}≤T_{C2}, such as (T_{C1}+2° C.)≤T_{B2}≤(T_{C2}-2° C.), especially (T_{C1}+5° C.)≤T_{B2}≤(T_{C2}−2° C.), like (T_{C1}+5° C.)≤T_{B2}≤(T_{C2}−5° C.). Hence, in specific embodiments, the method comprises selecting during the second sub-stage (T_{C1}+5° C.)≤T_{B2}≤(T_{C2}−2° C.).

In embodiments, the n₁ first layers may comprise a first subset (s₁₁) comprising n₁₁ first layers and a second subset (s₁₂) comprising the n₁₂ first layers. Especially, the first subset (s₁₁) of n₁₁ first layers may be in contact with the receiver item. The second subset (s₁₂) of n₁₂ first layers may in embodiments be configured on top of the first subset (s₁₁). Especially, n₁=n₁₁+n₁₂. In embodiments n₁₁≥1, like n₁₁≥3, such as n₁≥5. In further embodiments n₁₂≥1, like n₁₂≥3, such as n₁₂≥5. Hence, in embodiments n₁>2, such as n₁≥4, like n₁≥6, especially n₁≥8, such as n₁≥10. Especially, during the second sub-stage the method may comprise actively cooling the second subset (s₁₂) comprising the n₁₂ first layers of the n₁ first layers. In specific embodiments, the second subset (s₁₂) may be cooled to a temperature below T_{M2}, such as below T_{C2}, like below (T_{C2}−2° C.), such as below (T_{C2}−5° C.). In embodiments during the second sub-stage the method may comprise selecting the second receiver item temperature T_{B2} of the receiver item, wherein T_{B2}≥T_{C1}, like T_{B2}≥(T_{C1}+T_{C2})/2, such as T_{B2}≥T_{C2}, especially T_{B2}≥(T_{M1}+T_{M2})/2, such as T_{B2}≥T_{M2}. Hence, in specific embodiments, the n₁ first layers comprise a first subset (s₁₁) comprising n₁₁ first layers and a second subset (s₁₂) comprising the n₁₂ first layers, wherein the first subset (s₁₁) of n₁₁ first layers is in contact with the receiver item, wherein the second subset (s₁₂) of n₁₂ first layers is configured on top of the first subset (s₁₁); and wherein the method comprises during the second sub-stage actively cooling the second subset (s₁₂) comprising the n₁₂ first layers of the n₁ first layers to a temperature below T_{C2}, and selecting the second receiver item temperature T_{B2} of the receiver item, wherein T_{B2}>T_{M2}. In this way, the first subset (s₁₁) may remain melted and may provide adhesion of the 3D item to the receiver item. The second subset (s₁₂) may be solidified and may provide rigidity to the 3D item.

In specific embodiments, actively cooling the second subset (s₁₂) may be done by directing a flow of gas such as air to the second subset (s₁₂) comprising the n₁₂ first layers. In further embodiments, during the second sub-stage the method may comprise selecting T_{M2}≤T_{B2}≤(T_{M2}+15° C.), such as T_{M2}≤T_{B2}≤(T_{M2}+10° C.), like T_{M2}≤T_{B2}≤(T_{M2}+5° C.), especially T_{M2}≤T_{B2}≤(T_{M2}+2° C.). Hence, in specific embodiments, the method comprises during the second sub-stage: directing a flow of gas to the second subset (s₁₂) comprising the n₁₂ first layers, and selecting T_{M2}≤T_{B2}≤(T_{M2}+5° C.). In embodiments, the gas in the flow of gas has a temperature T_{A} wherein T_{A}<T_{C2}, like T_{A}<T_{M1}, such as T_{A}<T_{C1}. Hence, in specific embodiments during the second sub-stage the gas in the flow of gas has a temperature T_{A} wherein T_{A}<T_{C2}. In this way, the second subset (s₁₂) may have a temperature below T_{C2}, especially below T_{C1}.

In embodiments, the printable material may comprise a first printable material comprising a semi-crystalline polymer having a first printable material first crystallization temperature T_{C1,1} and a first printable material second melting temperature T_{M2,1} and a second printable material comprising a polymer having a second printable material second melting temperature T_{M2,2}. Especially T_{M2,1}>T_{M2,2}. In specific embodiments, the method may comprise selecting during the first sub-stage T_{N}>T_{M2,1}, and T_{B1}>T_{C1,1}, such as T_{B1}>T_{M2,2}, like T_{B1}>T_{M2,1}. Especially, the method may comprise selecting during the second sub-stage T_{M2,2}<T_{B2}<(T_{M2,1}+5° C.), such as T_{M2,2}<T_{B2}<T_{M2,1}, like T_{M2,2}<T_{B2}<(T_{M2,1}-5° C.). Hence, in specific embodiments, the printable material comprises (i) a first printable material comprising a semi-crystalline polymer having a first printable material second melting temperature T_{M2,1} and (ii) a second printable material comprising a polymer having a second printable material second melting temperature T_{M2,2}; wherein T_{M2,1}>T_{M2,2}; wherein the method comprises selecting during the first sub-stage: T_{N}>T_{M2,1}, and T_{B1}>T_{M2,1}; and selecting during the second sub-stage T_{M2,2}<T_{B2}<T_{M2,1}. The first printable material may have a second crystallization temperature T_{C2,1}. In embodiments, the method comprises selecting during the second sub-stage T_{M2,2}<T_{B2}<T_{C2,1}, such as (T_{M2,2}+2° C.)<T_{B2}<T_{C2,1}−2° C.), like (T_{M2,2}+5° C.)<T_{B2}<T_{C2,1}−5° C.). Hence, in specific embodiments the first printable material has a second crystallization temperature T_{C2,1} wherein the method comprises selecting during the second sub-stage T_{M2,2}<T_{B2}<T_{C2,1}.

Terms herein like “first printable material first crystallization temperature”, and similar terms, refer to the first crystallization temperature of the first printable material. Analogously, other terms herein may be explained.

The method may in embodiments comprise a fourth sub-stage of the 3D printing stage. The fourth sub-stage may especially be subsequent to the third sub-stage. The fourth sub-stage may especially be removing the 3D item from the receiver item in order to obtain the 3D item. During the fourth sub-stage the method may comprise extruding no printable material and cooling the 3D item to a temperature below 50° C., like below 30° C., such as to room temperature, and removing the 3D item from the receiver item. The fourth sub-stage may in embodiments further comprise cooling the receiver item to a temperature below 50° C., like below 30° C., such as to room temperature. Hence, in specific embodiments, the method comprises during a fourth sub-stage of the 3D printing stage: cooling the 3D item to a temperature below 50° C., and removing the 3D item from the receiver item.

Adhesion of the 3D printed material may also depend on properties of the receiver item. E.g. a rough surface of the receiver item may increase a contact area of the 3D printed item and the receiver item and hence the rough surface may improve adhesion. The receiver item may in embodiments have a surface roughness selected from the range of 1-100 μm, such as at least 2 μm, like up to about 90 μm. The surface roughness may be defined by the root mean square (RMS) roughness parameter. The root mean square roughness may be obtained by squaring each height value in the dataset, followed by taking the square root of the mean. In alternative embodiments, the receiver item may comprise a smooth surface, such as a glass surface. In specific embodiments, the glass surface may have a roughness less than 1 μm, such as less than 500 nm. The n₁ first layers have a total layer height (H₁). The total layer height (H₁) of the n₁ first layers may in embodiments be selected from the range of 0.2-10 mm, like from the range of 0.5-6 mm, such as from the range of 1-5 mm. In embodiments during the third sub-stage, the method may comprise selecting a third receiver item temperature T_{B3}, especially wherein T_{B3}≤T_{B2}. The nozzle temperature may in embodiments be T_{N}>T_{M2}. In embodiments, during the third sub-stage the method may comprise depositing n₂ second layers on the previously deposited n₁ first layers wherein n₂>n₁. Hence, in specific embodiments the receiver item has a surface roughness selected from the range of 1-100 μm and wherein the n₁ first layers have a total layer height (H₁) selected from the range of 0.5-6 mm; wherein the method comprises during the third sub-stage: selecting a third receiver item temperature T_{B3}; and wherein n₂>n₁.

The method of the invention may also apply to printing a brim. A brim in 3D printing is a layer of printed material that may extend along edges of the 3D item. The brim may improve adhesion of the 3D item to the receiver item. Additionally or alternatively, the brim may prevent warping of the 3D item. In embodiments, the first layers may comprise the brim. The brim may especially comprise the same 3D printed material as the layers printed during the first sub-stage of the 3D printing stage. In alternative embodiments, the brim may comprise a different 3D printed material compared to the layers printed during the first sub-stage of the 3D printing stage.

As indicated above, the method of the invention especially relates to 3D printing 3D printable material comprising semi-crystalline polymers. Hence, in specific embodiments, the 3D printable material and the 3D printed material may comprise one or more of polyethylene (PE), low-density polyethylene (LDPE), medium-density polyethylene (MDPE), high-density polyethylene (HDPE), polypropylene (PP), polyamides (PA), polycaprolactone (PCL), polylactic acid (PLA) polyvinyl alcohol (PVA), polyvinylidene fluoride (PVDF), crystalline polyethylene terephthalate (cPET), polybutylene terephthalate (PBT), polyhydroxyalkanoates (PHAs), and polybutylene succinate (PBS).

In specific embodiments, the 3D printable material being deposited during the first sub-stage may be the same as the 3D printable material being deposited during the third sub-stage. Hence, the 3D printed material deposited during the first sub-stage may be the same as the 3D printed material being deposited during the third sub-stage. In alternative embodiments, the 3D printable material being deposited during the first sub-stage may differ the 3D printable material being deposited during the third sub-stage. Hence, the 3D printed material deposited during the first sub-stage may differ from the 3D printed material being deposited during the third sub-stage. In yet further embodiments, the 3D printable material being deposited during the first sub-stage may be the same as the 3D printable material being deposited during part of the third sub-stage. Hence, the 3D printed material deposited during the first sub-stage may be the same as the 3D printed material being deposited during part of the third sub-stage. Especially, the third sub-stage may in embodiments comprise more than one 3D printable (and hence printed) material. In this way, the 3D item may have optical effects.

As indicated above, the method comprises depositing during a printing stage 3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. In embodiments, the 3D printable material may be printed as a filament and deposited as such. The 3D printable material may be provided as filament or may be formed into a filament. Hence, whatever starting materials are applied, a filament comprising 3D printable material may be provided by the printer head and 3D printed. The term “extrudate” may be used to define the 3D printable material downstream of the printer head, but not yet deposited. The latter may be indicated as “3D printed material”. In fact, the extrudate may be considered to comprise 3D printable material, as the material is not yet deposited. Upon deposition of the 3D printable material or extrudate, the material may thus be indicated as 3D printed material. Essentially, the materials may be the same material, as the thermoplastic material upstream of the printer head, downstream of the printer head, and when deposited, may essentially be the same material(s).

Herein, the term “3D printable material” may also be indicated as “printable material”. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and /r a melting point (Tₘ), and the printer head action may comprise heating the 3D printable material above the glass transition and in embodiments above the melting temperature (especially when the thermoplastic polymer is a semi-crystalline polymer). In yet another embodiment, the 3D printable material comprises a (thermoplastic) polymer having a melting point (Tₘ), and the 3D printing stage may comprise heating the 3D printable material to be deposited on the receiver item to a temperature of at least the melting point. The glass transition temperature is in general not the same thing as the melting temperature. Melting is a transition which may occur in crystalline polymers. Melting may happen when the polymer chains fall out of their crystal structures, and become a disordered liquid. The glass transition may be a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former. The glass temperature may e.g. be determined with differential scanning calorimetry. The melting point or melting temperature can also be determined with differential scanning calorimetry.

Materials that may especially qualify as (first or second) 3D printable materials may be selected from the group consisting of metals, glasses, thermoplastic polymers, silicones, etc. Especially, the (first or second) 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, such as thermoplastic elastomer based on copolyester elastomers, polyurethane elastomers, polyamide elastomers polyolefine based elastomers, styrene based elastomers, etc. Optionally, the (first or second) 3D printable material may comprise a 3D printable material selected from the group consisting of Urea formaldehyde, Polyester resin, Epoxy resin, Melamine formaldehyde, thermoplastic elastomer, etc. Optionally, the (first or second) 3D printable material may comprise a 3D printable material selected from the group consisting of a polysulfone. Elastomers, especially thermoplastic elastomers, may especially be interesting as they are flexible and may help obtaining relatively more flexible filaments comprising the thermally conductive material. A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Suitable thermoplastic materials, such as also mentioned in WO2017/040893, may include one or more of polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylsulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polycarbonates, polyethylene terephthalates, polyethylene naphtholates, polybutylene terephthalates, polyarylates), and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination comprising at least one of the foregoing thermoplastic polymers. Embodiments of polyamides may include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are poly(C₁₋₆ alkyl)acrylates and poly(C₁₋₆ alkyl)methacrylates, which include, for instance, polymers of methyl acrylate, ethyl acrylate, acrylamide, methacrylic acid, methyl methacrylate, n-butyl acrylate, and ethyl acrylate, etc. In embodiments, a polyolefine may include one or more of polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene.

In specific embodiments, the (first or second) 3D printable material (and the (first or second) 3D printed material) may comprise one or more of polycarbonate (PC), polyethylene (PE), high-density polyethylene (HDPE), polypropylene (PP), polyoxymethylene (POM), polyethylene naphthalate (PEN), styrene-acrylonitrile resin (SAN), polysulfone (PSU), polyphenylene sulfide (PPS), and semi-crystalline polytethylene terephthalate (PET), acrylonitrile butadiene styrene (ABS), poly(methyl methacrylate) (PMMA), polystyrene (PS), and styrene acrylic copolymers (SMMA).

The term 3D printable material is further also elucidated below, but may especially refer to a thermoplastic material, optionally including additives, to a volume percentage of at maximum about 60%, especially at maximum about 30 vol. %, such as at maximum 20 vol. % (of the additives relative to the total volume of the thermoplastic material and additives).

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

The printable material in embodiments may comprise particulate material, i.e. particles embedded in the printable polymeric material, which particles form a substantially discontinuous phase. The number of particles in the total mixture may especially not be larger than 60 vol. %, relative to the total volume of the printable material. For optical and surface related effect number of particles in the total mixture is equal to or less than 20 vol. %, such as up to 10 vol. %, relative to the total volume of the printable material (including the particles). Hence, the 3D printable material may especially refer to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

The method of the invention may also be desirable for 3D printing core-shell layers wherein the shell printable material comprises a semi-crystalline polymer. When using a core-shell nozzle, the 3D printable material provided to the core of the core-shell nozzle may be a filament comprising 3D printable material or may be particulate 3D printable material. Both type of feeds may be extruded via the core of the core-shell nozzle. The 3D printable material provided to a shell of the core-shell nozzle may be particulate 3D printable material. Such particulate 3D printable material (feed) may be extruded via the shell of the core-shell nozzle. When using a nozzle with a single opening, the 3D printable material provided to nozzle may be a filament comprising 3D printable material or may be particulate 3D printable material. Both type of feeds may be extruded via the nozzle.

The printable material may be printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material may be deposited, by which the 3D printed item may be generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc. Post-processing may include smoothening the ribbed structures, which may lead to an essentially smooth surface.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein.

Hence, in an aspect the invention (thus) provides a software product, which, when running on a computer is capable of bringing about (one or more embodiments of) the method (for producing a 3D item by means of fused deposition modelling) as described herein.

The herein described method provides 3D printed items. Hence, the invention also provides in a further aspect a 3D printed item obtainable with the herein described method. In a further aspect a 3D printed item obtainable with the herein described method is provided. Especially, the invention provides a 3D item comprising 3D printed material. Especially, the 3D item comprises a plurality of layers of 3D printed material. In embodiments, the 3D item may comprise a stack of 3D printed layers. The stack of 3D printed layers comprises n₁ first layers and n₂ second layers. One of the n₁ first layers and one of the n₂ second layers may in embodiments be configured in contact with each other. In specific embodiments, at least one first layer of the n₁ first layers may have a higher first crystallinity than a second crystallinity of one or more other n₁ first layers. Additionally or alternatively, at least one first layer of the n₁ first layers may have a higher first crystallinity than the one of the second layers in contact with the one of the first layers. Especially, the at least one first layer of the n₁ first layers having a higher first crystallinity may in embodiments be an edge layer, e.g. the first layer that was deposited directly on the receiver item. Hence, in specific embodiments, the invention provides a 3D item comprising 3D printed material, wherein the 3D item comprises a plurality of layers of 3D printed material, wherein the 3D item comprises a stack of 3D printed layers, wherein (i) the stack of 3D printed layers comprises n₁ first layers and n₂ second layers; wherein one of the n₁ first layers and one of the n₂ second layers are configured in contact with each other; and (ii) at least one first layer of the n₁ first layers has a higher first crystallinity than a second crystallinity of one or more of: (a) one or more optionally other n₁ first layers, and (b) the one of the second layers in contact with the one of the first layers.

Such 3D item may especially be obtained by the method of the invention. Fast cooling (by cooling the 3D printed material at a temperature below the first crystallization temperature) of a semi-crystalline polymer may result in an amorphous solid, having a relatively low crystallinity. Alternatively, slow cooling (by cooling the 3D printed material at a temperature within the crystallization range) a crystalline solid may be obtained, having a relatively high crystallinity.

Crystallinity may e.g. be determined by using e.g. DSC measurements and/or X-ray diffraction. DSC measurements may measure the heat flow required to melt the solid polymer (enthalpy of transition). Crystallinity may then be determined by normalization of the measured heat flow to (literature values of) the required heat flow to melt a 100% crystalline polymer. From an X-ray diffraction spectrum, crystallinity may be calculated from the ratio of an integrated area of all crystalline peaks to a total integrated area of all peaks.

Especially, the 3D item comprises one or more layers of 3D printed material. More especially, the 3D item comprises a plurality of layers of 3D printed material. The 3D item may comprise two or more, like at least 5, such as at least 10, like in embodiments at least 20 layers of 3D printed material.

As indicated above, the printable material may comprise a semi-crystalline polymer and hence the printed material may comprise a semi-crystalline polymer. In specific embodiments, a crystallinity of a first group of the layers is higher than a crystallinity of a second group of the layers. Hence, in specific embodiments the 3D printed material comprises a semi-crystalline polymer, wherein a crystallinity of a first group of the layers is higher than a crystallinity of a second group of the layers.

More specifically, the first subset of the layers has a first degree of crystallinity C₁ and a second subset of the layers has a second degree of crystallinity C₂. In specific embodiments C₁/C₂<0.95, like C₁/C₂<0.9, such as C₁/C₂<0.8, especially C₁/C₂<0.7. In alternative embodiments C₁/C₂>1.05, like C₁/C₂>1.1, such as C₁/C₂>1.2, especially C₁/C₂>1.3. Hence, in specific embodiments, the first subset of the layers has a first degree of crystallinity C₁ and a second subset of the layers has a second degree of crystallinity C₂, wherein C₁/C₂<0.9 or C₁/C₂>1.1.

In specific embodiments, all layers of the 3D item comprise the same 3D printed material. However, in alternative embodiments, the 3D printed material in one or more layers of the 3D item may differ from the 3D printed material in one or more other layers of the 3D item.

The 3D printed item may comprise a plurality of layers on top of each other, i.e. stacked layers. The width (thickness) and height of (individually 3D printed) layers may e.g. in embodiments be selected from the range of 100-5000 μm, such as 200-2500 μm, with the height in general being smaller than the width. For instance, the ratio of height and width may be equal to or smaller than 0.8, such as equal to or smaller than 0.6.

Layers may be core-shell layers or may consist of a single material. Within a layer, there may also be a change in composition, for instance when a core-shell printing process was applied and during the printing process it was changed from printing a first material (and not printing a second material) to printing a second material (and not printing the first material).

At least part of the 3D printed item may include a coating.

Some specific embodiments in relation to the 3D printed item have already been elucidated above when discussing the method. Below, some specific embodiments in relation to the 3D printed item are discussed in more detail.

As indicated above, the method of the invention especially relates to 3D printing 3D printable material comprising semi-crystalline polymers. Hence, the 3D item obtainable by the method of the invention, may especially comprise 3D printed material comprising semi-crystalline polymers. Hence, in specific embodiments, the 3D printable material and the 3D printed material may comprise one or more of polyethylene (PE), low-density polyethylene (LDPE), medium-density polyethylene (MDPE), high-density polyethylene (HDPE), polypropylene (PP), polyamides (PA), polycaprolactone (PCL), polylactic acid (PLA) polyvinyl alcohol (PVA), polyvinylidene fluoride (PVDF), crystalline polyethylene terephthalate (cPET), polybutylene terephthalate (PBT), polyhydroxyalkanoates (PHAs), and polybutylene succinate (PBS).

In specific embodiments of the method of the invention, the printable material may comprise a first printable material comprising a semi-crystalline polymer and a second printable material. Hence, in embodiments of the 3D item, the printed material may comprise a first printed material comprising a semi-crystalline polymer and a second printed material.

The (with the herein described method) obtained 3D printed item may be functional per se. For instance, the 3D printed item may be a lens, a collimator, a reflector, etc. The thus obtained 3D item may (alternatively) be used for decorative or artistic purposes. The 3D printed item may include or be provided with a functional component. The functional component may especially be selected from the group consisting of an optical component, an electrical component, and a magnetic component. The term “optical component” especially refers to a component having an optical functionality, such as a lens, a mirror, a light transmissive element, an optical filter, etc. The term optical component may also refer to a light source (like a LED). The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc. Alternatively, or additionally, the functional component may comprise a thermal component (e.g. configured to cool or to heat an electrical component). Hence, the functional component may be configured to generate heat or to scavenge heat, etc.

As indicated above, the 3D printed item maybe used for different purposes. Amongst others, the 3D printed item maybe used in lighting. Hence, in yet a further aspect the invention also provides a lighting device comprising the 3D item as defined herein. In a specific aspect the invention provides a lighting system comprising (a) a light source configured to provide (visible) light source light and (b) the 3D item as defined herein, wherein 3D item may be configured as one or more of (i) at least part of a housing, (ii) at least part of a wall of a lighting chamber, and (iii) a functional component, wherein the functional component may be selected from the group consisting of an optical component, a support, an electrically insulating component, an electrically conductive component, a thermally insulating component, and a thermally conductive component. Hence, in specific embodiments the 3D item may be configured as one or more of (i) at least part of a lighting device housing, (ii) at least part of a wall of a lighting chamber, and (iii) an optical element. As a relative smooth surface may be provided, the 3D printed item may be used as mirror or lens, etc. In embodiments, the 3D item may be configured as shade. A device or system may comprise a plurality of different 3D printed items, having different functionalities.

Returning to the 3D printing process, a specific 3D printer may be used to provide the 3D printed item described herein. Especially, the 3D printer may comprise a gas blowing device. The gas blowing device may in embodiments be configured to provide a flow of gas having a temperature T_{A} directed at at least part of the 3D printed material. The 3D printer may in embodiments further comprise a control system, wherein the control system is configured to execute with the fused deposition modeling 3D printer the method of the invention. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material on a receiver item; wherein the printer further comprises a gas blowing device configured to provide a flow of gas directed at least part of the 3D printed material, and (d) a control system, wherein the control system is configured to execute the method according to the method of the invention.

The printer nozzle may include a single opening. In other embodiments, the printer nozzle may be of the core-shell type, having two (or more) openings. The term “printer head” may also refer to a plurality of (different) printer heads; hence, the term “printer nozzle”may also refer to a plurality of (different) printer nozzles.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material on a receiver item; wherein the printer further comprises a gas blowing device configured to provide a flow of gas directed at least part of the 3D printed material, and (d) a control system, wherein the control system is configured to execute the method according to the method of the invention.

Especially, the gas blowing device may be configured near or on the receiver item. In embodiments, the 3D printer may comprise a plurality of gas blowing devices. The gas blowing device may in embodiments comprise one or more of a gas exit, wherein the gas exit may be configured directable. Especially, the gas exit may be directed at at least part of the 3D printed material. More especially, the gas exit may be configured such that the gas exiting the gas blowing device may be directed at the second subset (s₁₂) of first layers. In embodiments, the gas blowing device may be a fan, pump or generator. Especially, the gas blowing device may comprise a container comprising a gas. In specific embodiments, the gas may comprise one or more of air, nitrogen, oxygen, and carbon dioxide.

In specific embodiments, the gas blowing device may further comprise a temperature controller. Especially, the temperature controller may be configured to control the temperature T_{A} of the flow of gas directed at at least part of the 3D item. Additionally or alternatively, the temperature controller may be configured to control a temperature of the container comprising the gas.

Especially, the 3D printer comprises a controller (or is functionally coupled to a controller) that is configured to execute in a controlling mode (or “operation mode”) the method as described herein. Instead of the term “controller” also the term “control system” (see e.g. above) may be applied. The controller may especially be configured to control the gas blowing device. Especially, the controller may control one or more of gas pressure, gas flow speed, gas flow direction, gas temperature. Additionally or alternatively, the controller may be configured to control the temperature controller.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, WIFI, LiFi, ZigBee, BLE or WiMAX, or another wireless technology.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer”may refer to a clock and/or a predetermined time scheme.

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIGS. 2a-2b schematically depict some further aspects of the invention;

FIGS. 3a-3c schematically depict some specific embodiments of the invention;

FIG. 4 schematically depicts an application;

FIG. 5 schematically depicts some further aspects of the 3D printer.

The schematic drawings are not necessarily to scale.

### DETAILED DESCRIPTION OF THE EMBODIMENTS

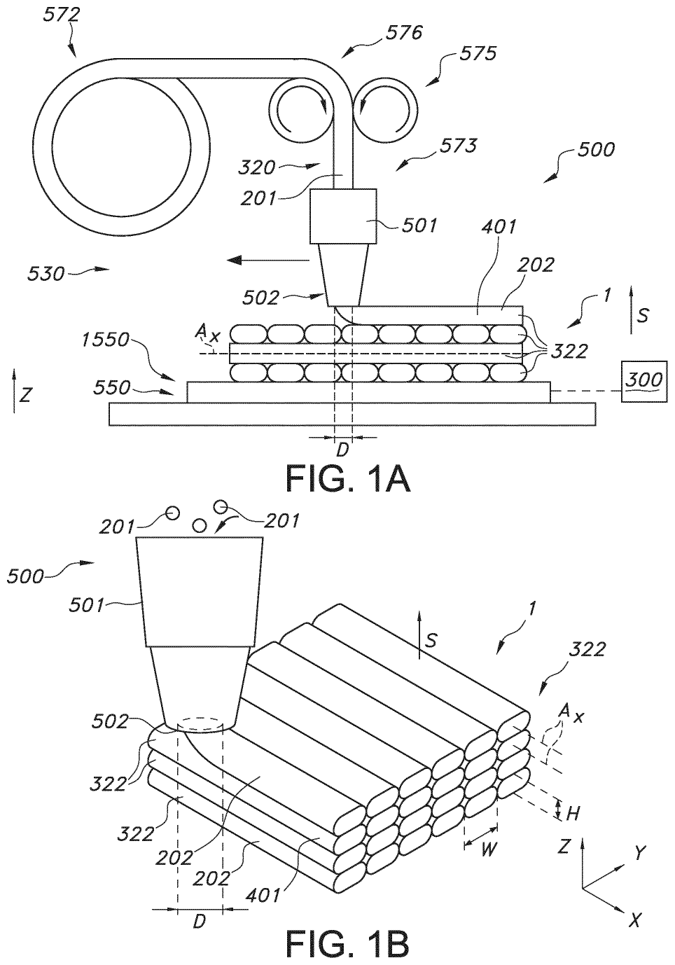

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit.

Here, only the printer head for providing 3D printed material, such as an FDM 3D printer head is schematically depicted. Reference 501 indicates the printer head. The 3D printer of the present invention may especially include a plurality of printer heads (see below). Reference 502 indicates a printer nozzle. The 3D printer of the present invention may especially include a plurality of printer nozzles, though other embodiments are also possible. Reference 320 indicates a filament of printable 3D printable material (such as indicated above).

Instead of a filament also pellets may be used as 3D printable material. Both can be extruded via the printer nozzle.

For the sake of clarity, not all features of the 3D printer have been depicted, only those that are of especial relevance for the present invention (see further also below). Reference 321 indicates extrudate (of 3D printable material 201).

The 3D printer 500 is configured to generate a 3D item 1 by layer-wise depositing on a receiver item 550, which may in embodiments at least temporarily be cooled, a plurality of layers 322 wherein each layers 322 comprises 3D printable material 201, such as having a melting point Tₘ. The 3D printable material 201 may be deposited on a substrate 1550 (during the printing stage). By deposition, the 3D printable material 201 has become 3D printed material 202. 3D printable material 201 escaping from the nozzle 502 is also indicated as extrudate 321. Reference 401 indicates thermoplastic material.

The 3D printer 500 may be configured to heat the filament 320 material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in an extrudate 321 downstream of the printer nozzle which becomes a layer 322 on the receiver item or on already deposited printed material. In general, the diameter of the extrudate 321 downstream of the nozzle 502 is reduced relative to the diameter of the filament 320 upstream of the printer head 501. Hence, the printer nozzle is sometimes (also) indicated as extruder nozzle. Arranging layer 322 by layer 322, a 3D item 1 may be formed. Reference 575 indicates the filament providing device, which here amongst others include the spool or roller and the driver wheels, indicated with reference 576.

Reference Ax indicates a longitudinal axis or filament axis.

Reference 300 schematically depicts a control system. The control system may be configured to control the 3D printer 500. The control system 300 may be comprised or functionally coupled to the 3D printer 500. The control system 300 may further comprise or be functionally coupled to a temperature control system configured to control the temperature of the receiver item 550 and/or of the printer head 501. Such temperature control system may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material. Hence, the nozzle 502 may effectively produce from particulate 3D printable material 201 a filament 320, which upon deposition is indicated as layer 322 (comprising 3D printed material 202). Note that during printing the shape of the extrudate may further be changes, e.g. due to the nozzle smearing out the 3D printable material 201/3D printed material 202. FIG. 1b schematically depicts that also particulate 3D printable material 201 may be used as feed to the printer nozzle 502.

Reference D indicates the diameter of the nozzle (through which the 3D printable material 201 is forced). However, the nozzle is not necessarily circular.

FIG. 1b schematically depicts in 3D in more detail the printing of the 3D item 1 under construction. Here, in this schematic drawing the ends of the layers in a single plane are not interconnected, though in reality this may in embodiments be the case. Reference H indicates the height of a layer. Layers are indicated with reference 322. Here, the layers have a flattened, cross-section such as having an outer shape resembling a flat oval tube or flat oval duct (i.e. a circular shaped bar having a diameter that is compressed to have a smaller height than width, wherein the sides (defining the width) are (still) rounded).

Hence, FIG. 1a schematically depict some aspects of a fused deposition modeling 3D printer 500, comprising (a) a first printer head 501 comprising a printer nozzle 502, (b) a filament providing device 575 configured to provide a filament 320 comprising 3D printable material 201 to the first printer head 501, and optionally (c) a receiver item 550, which can be used to provide a layer of 3D printed material 202.

FIG. 1b schematically depict some aspects of a fused deposition modeling 3D printer 500 (or part thereof), comprising a first printer head 501 comprising a printer nozzle 502, and optionally a receiver item (not depicted), which can be used to which can be used to provide a layer of 3D printed material 202. Such fused deposition modeling 3D printer 500 may further comprise a 3D printable material providing device, configured to provide the 3D printable material 201 to the first printer head.

In FIGS. 1a-1b, the first or second printable material or the first or second printed material are indicated with the general indications printable material 201 and printed material 202, respectively. Downstream of the nozzle 502, the filament 320 with 3D printable material becomes, when deposited, layer 322 with 3D printed material 202. In FIG. 1b, by way of example the extrudate is essentially directly the layer 322 of 3D printed material 202, due to the short distance between the nozzle 502 and the 3D printed material (or receiver item (not depicted).

FIG. 1c schematically depicts a stack of 3D printed layers 322, each having a layer height H and a layer width W. Note that in embodiments the layer width and/or layer height may differ for two or more layers 322. The layer width and/or layer height may also vary within a layer. Reference 252 in FIG. 1c indicates the item surface of the 3D item (schematically depicted in FIG. 1c).

Referring to FIGS. 1a-1c, the filament of 3D printable material that is deposited leads to a layer having a height H (and width W). Depositing layer 322 after layer 322, the 3D item 1 is generated. FIG. 1c very schematically depicts a single-walled 3D item 1.

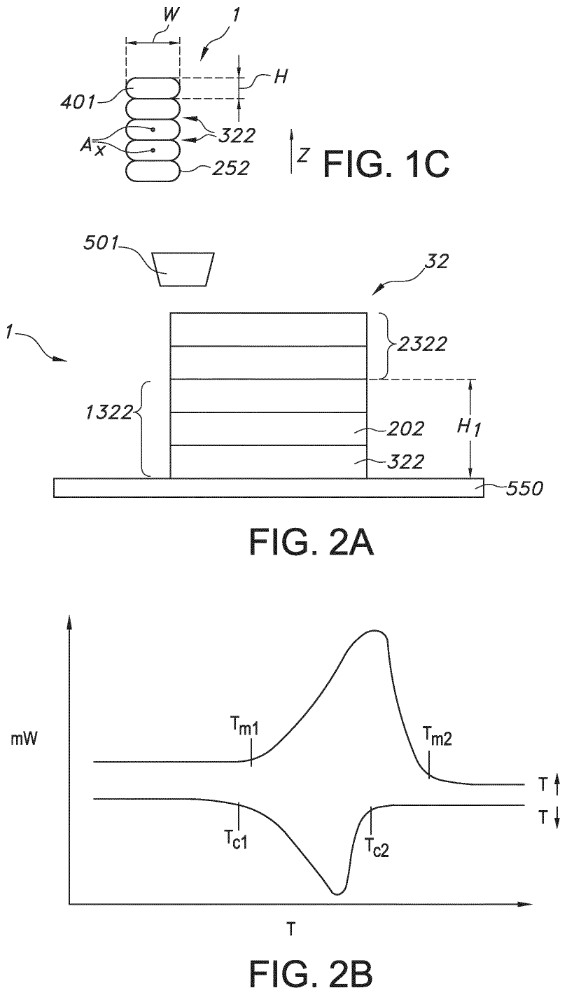

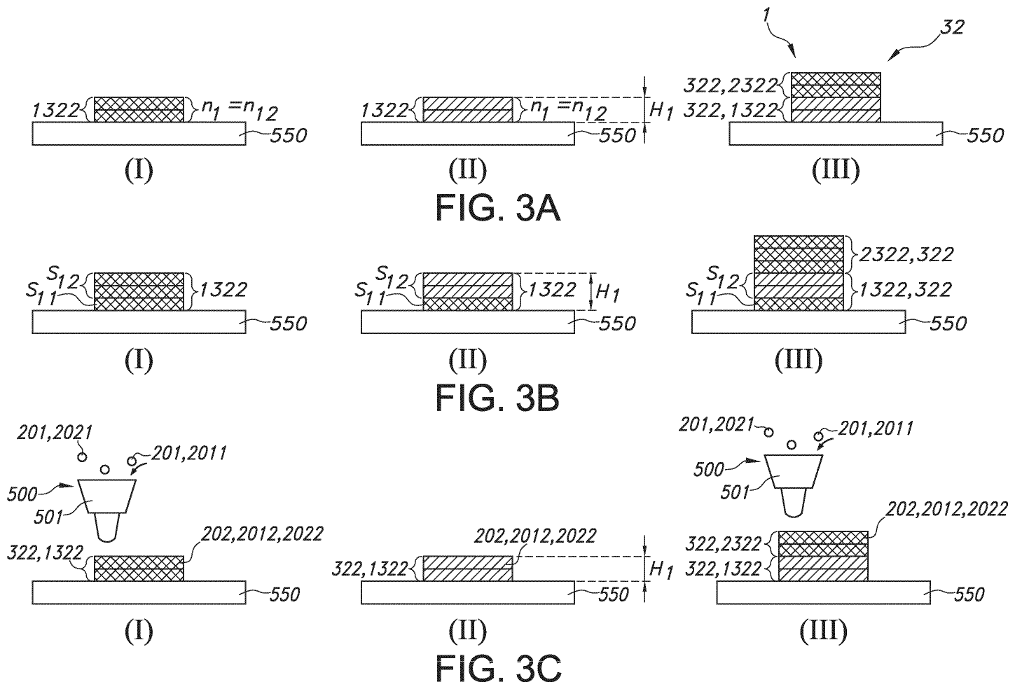

FIG. 2a schematically depicts an item 1, obtainable via a method for producing a 3D item 1 by means of fused deposition modelling. As already depicted in FIGS. 1a-b, the method may especially comprise a 3D printing stage comprising layer-wise depositing 3D printable material 201, to provide the 3D item 1 comprising 3D printed material 202 on a receiver item 550. The 3D item 1 may especially comprise a plurality of layers 322 of 3D printed material 202. Especially, the 3D printing stage may comprise guiding the 3D printable material 201 through a printer nozzle 502 at a nozzle temperature T_{N}. Especially, the method may comprise (during one or more of the first sub-stage and the third sub-stage) T_{N}>T_{M2}. Temperatures T_{M1}, T_{M2}, T_{C1}, and T_{C2} are further explained in relation to FIG. 2b. In specific embodiments, the method may comprise during a first sub-stage of the 3D printing stage: depositing 3D printable material 201 on the receiver item 550 having a first receiver item temperature T_{B1}, to provide n₁ first layers 1322 on the receiver item 550. In embodiments of the first sub-stage T_{B1}≥T_{C1}, such as T_{B1}≥T_{M1}, like T_{B1}≥T_{C2}, such as T_{B1}≥T_{M2}. In embodiments, T_{B1}<T_{N}. In specific embodiments, n₁≥1, in the depicted embodiment n₁=3. In further embodiments, the method may comprise during a second sub-stage of the 3D printing stage: cooling n₁₂ first layers 1322 of the n₁ first layers 1322 and selecting a second receiver item temperature T_{B2} of the receiver item 550, wherein T_{B2}≤T_{B1}. Specific embodiments of cooling n₁₂ first layers 1322 is depicted in FIGS. 3a-c. The method may further comprise during a third substage of the 3D printing stage: depositing 3D printable material 201 on the previously deposited n₁ first layers 1322, to provide n₂ second layers 2322 thereon. Especially, the method may comprise during the third sub-stage: selecting a third receiver item temperature T_{B3}. In specific embodiments T_{B3}≤T_{B2}. In embodiments, n₂≥1, in the depicted embodiment n₂=2. In further embodiments n₂>n₁.

In embodiments, the receiver item 550 may have a surface roughness selected from the range of 1-100 μm. The n₁ first layers 1322 may in embodiments have a total layer height (H₁) selected from the range of 0.5-6 mm.

FIG. 2b schematically depicts material properties of the printable material 201 in a thermogram, having heat flow (mW) plotted against temperature. In embodiments, the printable material 201 and printed material 202 may comprise a semi-crystalline polymer. The 3D printable material has a melting temperature range, ranging from a first melting temperature T_{M1} to a second melting temperature T_{M2}, wherein T_{M2}>T_{M1}. The melting temperature range may especially be measured while heating solid 3D printable material, e.g. using DSC. The 3D printable material has a crystallization temperature range, ranging from a second crystallization temperature T_{C2} to a first crystallization temperature T_{C1}, wherein T_{C2}>T_{C1}. The crystallization temperature range may especially be measured while cooling melted 3D printable material, e.g. using DSC. The method of the invention comprises selecting temperatures (such as nozzle temperature, receiver item temperature) in relation to T_{M1}, T_{M2}, T_{C1}, and T_{C2}.

In specific embodiments, the 3D printable material 201 and the 3D printed material 202 may comprise one or more of polyethylene (PE), low-density polyethylene (LDPE), medium-density polyethylene (MDPE), high-density polyethylene (HDPE), polypropylene (PP), polyamides (PA), polycaprolactone (PCL), polylactic acid (PLA) polyvinyl alcohol (PVA), polyvinylidene fluoride (PVDF), crystalline polyethylene terephthalate (cPET), polybutylene terephthalate (PBT), polyhydroxyalkanoates (PHAs), and polybutylene succinate (PBS).

Essentially, the method of the invention comprises multiple alternative routes to obtain the desired structural and adhesive properties as indicated above. FIGS. 3a-3c depict three specific embodiments according to the method of the invention. However, other embodiments are also possible. Double hatched layers 1322 and 2322 indicate relatively warm layers, compared to single hatched layers 1322 and 2322.

FIG. 3a depicts a first embodiment. During a first sub-stage (I), the method comprises depositing n₁ first layers 1322 on the receiver item 550, wherein the receiver item 550 has the first receiver item temperature T_{B1}≥T_{M2}. During the second sub-stage (II), the method comprises selecting T_{B2} such that n₁₂ layers of the first layers 1322 are cooled below T_{M2}, especially below T_{C2}. In specific embodiments, T_{B2} may be selected from the range of T_{C1}<T_{B2}<T_{M2}. Especially, T_{B2} may be selected from the range of T_{C1}≤T_{B2}≤T_{C2}, such as (T_{C1}+2° C.)≤T_{B2}≤(T_{C2}−2° C.), especially (T_{C1}+5° C.)≤T_{B2}≤(T_{C2}−2° C.), like (T_{C1}+5° C.)≤T_{B2}≤(T_{C2}−5° C.). During the third sub-stage (III), the method comprises depositing n₂ second layers 2322 on the previously deposited n₁ first layers 1322.

FIG. 3b depicts a second embodiment of the method of the invention. During a first sub-stage (I), the method comprises depositing n₁ first layers 1322 on the receiver item 550, wherein the receiver item 550 has the first receiver item temperature T_{B1}≥T_{M2}. Especially, the n₁ first layers 1322 comprise a first subset (s₁₁) comprising n₁₁ first layers 1322 and a second subset (s₁₂) comprising the n₁₂ first layers 1322, wherein the first subset (s₁₁) of n₁₁ first layers 1322 is in contact with the receiver item 550, wherein the second subset (s₁₂) of n₁₂ first layers 1322 is configured on top of the first subset (s₁₁). In specific embodiments, n₁₂≥1. During the second sub-stage (II), the method comprises actively cooling the second subset (s₁₂) comprising the n₁₂ first layers 1322 of the n₁ first layers 1322 to a temperature below T_{C2}. The active cooling may especially comprise directing a flow of gas (such as air) to the second subset (s₁₂) comprising the n₁₂ first layers 1322. In embodiments, the gas in the flow of gas may have a temperature T_{A} wherein T_{A}<T_{C2}, like T_{A}<T_{M1}, such as T_{A}<T_{C1}. The method further comprises during the second sub-stage selecting the second receiver item temperature T_{B2} of the receiver item 550, wherein T_{B2}≥T_{M2}. In specific embodiments, the method comprises during the second sub-stage selecting T_{M2}≤T_{B2}≤(T_{M2}+5° C.). During the third sub-stage (III), the method comprises depositing n₂ second layers 2322 on the previously deposited n₁ first layers 1322.

FIG. 3c depicts a third embodiment of the method of the invention. During a first sub-stage (I), the method comprises depositing 3D printable material 201 on the receiver item 550 to provide n₁ first layers 1322, wherein the receiver item 550 has the first receiver item temperature T_{B1}≥T_{M2}. In the depicted embodiment, the printable material 201 comprises (i) a first printable material 2011 comprising a semi-crystalline polymer having a first printable material second melting temperature T_{M2,1} and a second crystallization temperature T_{C2,1} and (ii) a second printable material 2021 comprising a polymer having a second printable material second melting temperature T_{M2,2}. Especially wherein T_{M2,1}>T_{M2,2}. The method especially comprises selecting during the first sub-stage T_{N}>T_{M2,1}, and T_{B1}>T_{M2,1}. During the second sub-stage (II), the method comprises selecting T_{B2} such that n₁₂ layers of the first layers 1322 comprising first printed material 2012 and second printed material 2022 are cooled below T_{M2,1}, especially below T_{C2,1}. In specific embodiments, T_{B2} may be selected from the range of T_{M2,2}<T_{B2}<(T_{M2,1}+5° C.), such as T_{M2,2}<T_{B2}<T_{M2,1}, like T_{M2,2}<T_{B2}<(T_{M2,1}−5° C.). More especially, T_{M2,2}<T_{B2}<T_{C2,1}, such as (T_{M2,2}+2° C.)<T_{B2}<T_{C2,1}−2° C.), like (T_{M2,2}+5° C.)<T_{B2}<T_{C2,1}−5° C.). During the third sub-stage (III), the method comprises depositing n₂ second layers 2322 on the previously deposited n₁ first layers 1322.

The stacks 32 of 3D printed layers 322 depicted in the third stages (III) in FIG. 3abc have been prepared via different embodiments comprising selecting temperatures. As a cooling trajectory of the 3D printed material 202 may influence its crystallinity, the method of the invention may result in differences in crystallinity within the stack 32. Layers 233 that are cooled at a temperature in the crystallization range, may have a high crystallinity. Layers that are cooled at a temperature below the crystallization range may have a low crystallinity and may be optically clear. Hence, the invention may relate to a 3D item 1 comprising 3D printed material 202, wherein the 3D item 1 comprises a plurality of layers 322 of 3D printed material 202, wherein the 3D item 1 comprises a stack 32. Especially the stack 32 of 3D printed layers comprises n₁ first layers 1322 and n₂ second layers 2322; wherein one of the n₁ first layers 1322 and one of the n₂ second layers 2322 are configured in contact with each other. In specific embodiments, at least one first layer 1322 of the n₁ first layers 1322 may have a higher first crystallinity than a second crystallinity of one or more optionally other n₁ first layers 1322. Additionally or alternatively, at least one first layer 1322 of the n₁ first layers 1322 may have a higher first crystallinity than a second crystallinity of one the one of the second layers 2322 in contact with the one of the first layers 1322. More specifically, the first subset of the layers 322 may have a first degree of crystallinity C1 and a second subset of the layers 322 may have a second degree of crystallinity C2, wherein C₁/C₂<0.9 or C₁/C₂>1.1.

For example, FIGS. 3a and 3c (III) schematically depict embodiments wherein two first layers 1322 have a higher crystallinity than the second layers 2322 in contact with the one of the first layers 1322.

Alternatively, FIG. 3b (III) schematically depicts an embodiment wherein two top layers 322 of the first layers 1322 have a higher crystallinity than the bottom layer of the first layers 1322. Also, the two top layers 322 of the first layers 1322 have a higher crystallinity than the second layers 2322 in contact with the one of the first layers 1322.

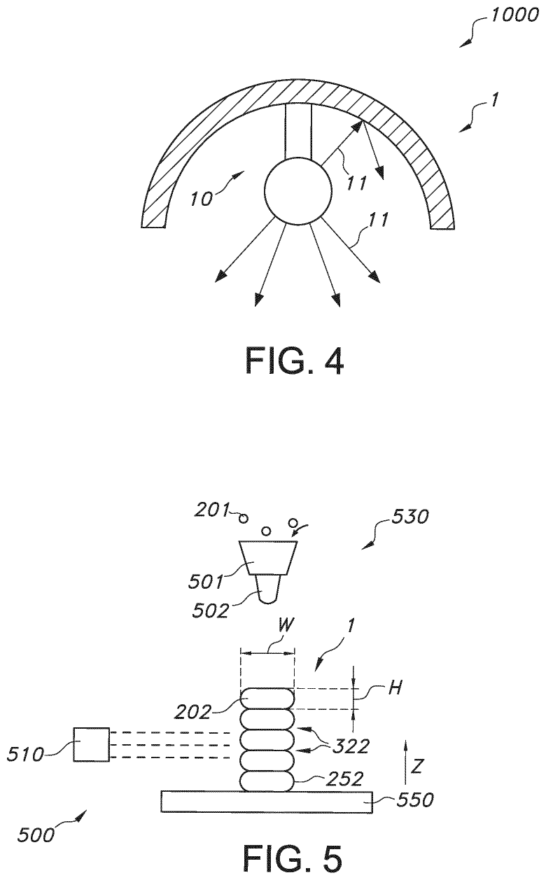

FIG. 4 schematically depicts an embodiment of a lamp or luminaire, indicated with reference 1, which comprises a light source 10 for generating light 11. The lamp may comprise a housing or shade or another element, which may comprise or be the 3D printed item 1. Here, the half sphere (in cross-sectional view) schematically indicates a housing or shade. The lamp or luminaire may be or may comprise a lighting device 1000 (which comprises the light source 10). Hence, in specific embodiments the lighting device 1000 comprises the 3D item 1. The 3D item 1 may be configured as one or more of (i) at least part of a lighting device housing, (ii) at least part of a wall of a lighting chamber, and (iii) an optical element. Hence, the 3D item may in embodiments be reflective for light source light 11 and/or transmissive for light source light 11. Here, the 3D item may e.g. be a housing or shade. Additionally or alternatively, the lighting device 1000 may comprise the 3D item 1, wherein the 3D item 1 may be configured as one or more of (i) at least part of a lighting device housing, (ii) at least part of a wall of a lighting chamber, and (iii) an optical element.

FIG. 5 schematically depicts a fused deposition modeling 3D printer 500 configured to execute embodiments of the method of the invention. The depicted fused deposition modeling 3D printer 500 comprises a printer head 501 comprising a printer nozzle 502. The 3D printer 500 is configured to provide 3D printable material 201 to the printer head 501. Especially, the fused deposition modeling 3D printer 500 is configured to provide said 3D printable material 201 on a receiver item 550. In further embodiments, the depicted 3D printer 500 comprises a gas blowing device 510 configured to provide a flow of gas directed at least part of the 3D printed material 202. The 3D printer may in embodiments further comprise a control system 300, wherein the control system 300 is configured to execute (with the fused deposition modeling 3D printer 500) the method of the invention. Especially, the control system 300 may control a temperature T_{A} of the gas in the flow of gas.

The term “plurality”refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” includes also embodiments wherein the term “comprises”means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications. It goes without saying that one or more of the first (printable or printed) material and second (printable or printed) material may contain fillers such as glass and fibers which do not have (to have) influence on the on T_{g} or Tₘ of the material(s).

1. A method for producing a 3D item by means of fused deposition modelling, wherein:
the method comprises a 3D printing stage comprising layer-wise depositing 3D printable material, to provide the 3D item comprising 3D printed material on a receiver item, wherein the 3D item comprises a plurality of layers of 3D printed material; wherein:
the printable material comprises a semi-crystalline polymer;
the 3D printable material has (i) a melting temperature range, ranging from a first melting temperature T_{M1} to a second melting temperature T_{M2}, wherein T_{M2}>T_{M1}, and (ii) a crystallization temperature range, ranging from a second crystallization temperature T_{C2} to a first crystallization temperature T_{C1}, wherein T_{C2}>T_{C1};
the 3D printing stage comprises guiding the 3D printable material through a printer nozzle at a nozzle temperature T_{N}; wherein T_{N}>T_{M2};
the method comprises during a first sub-stage of the 3D printing stage: depositing 3D printable material on the receiver item having a first receiver item temperature T_{B1}, to provide n₁ first layers on the receiver item; wherein T_{B1}≥T_{M2};
the method comprises during a second sub-stage of the 3D printing stage: cooling n₁₂ first layers of the n₁ first layers selecting a second receiver item temperature T_{B2} of the receiver item, wherein T_{B2}≤T_{B1}, and one of:
(i) selecting T_{B2}<T_{M2}, or
(ii) the n₁ first layers comprise a first subset (s₁₁) comprising n₁₁ first layers and a second subset (s₁₂) comprising the n₁₂ first layers, wherein the first subset (s₁₁) of n₁₁ first layers is in contact with the receiver item, wherein the second subset (s₁₂) of n₁₂ first layers is configured on top of the first subset (s₁₁), wherein cooling the n₁₂ first layers comprises actively cooling the second subset (s₁₂) comprising the n₁₂ first layers of the n₁ first layers to a temperature below T_{C2} and selecting the second receiver item temperature T_{B2} of the receiver item, wherein T_{B2}≥T_{M2};
and
the method comprises during a third sub-stage of the 3D printing stage: depositing 3D printable material on the previously deposited n₁ first layers, to provide n₂ second layers thereon.

2. The method according to claim 1, wherein the method comprises selecting during the second sub-stage T_{C1}<T_{B2}<T_{M2}.

3. The method according to claim 1, wherein the method comprises selecting during the second sub-stage (T_{C1}+5° C.)≤T_{B2}≤(T_{C2}−2° C.).

4. The method according to claim 1, wherein: the method comprises during the second sub-stage: directing a flow of gas to the second subset (s₁₂) comprising the n₁₂ first layers and selecting T_{M2}≥T_{B2}≤(T_{M2}+5° C.).

5. The method according to claim 4, wherein during the second sub-stage the gas in the flow of gas has a temperature T_{A} wherein T_{A}<T_{C2}.

6. The method according to claim 1, wherein the printable material comprises (i) a first printable material comprising a semi-crystalline polymer having a first printable material second melting temperature T_{M2,1} and (ii) a second printable material comprising a polymer having a second printable material second melting temperature T_{M2,2}; wherein T_{M2,1}>T_{M2,2}; wherein the method comprises:
selecting during the first sub-stage: T_{N}>T_{M2,1}, and T_{B1}>T_{M2,1}; and
selecting during the second sub-stage T_{M2,2}<T_{B2}<T_{M2,1}.

7. The method according to claim 6, wherein the first printable material has a second crystallization temperature T_{C2,1} wherein the method comprises selecting during the second sub-stage T_{M2,2}<T_{B2}<T_{C2,1}.

8. The method according to claim 1, wherein the receiver item has a surface roughness selected from the range of 1-100 μm and wherein the n₁ first layers have a total layer height H₁ selected from the range of 0.5-6 mm;
wherein the method comprises during the third sub-stage: selecting a third receiver item temperature T_{B3}; and wherein n₂>n₁.

9. The method according to claim 1, wherein the 3D printable material and the 3D printed material comprise one or more of polyethylene (PE), low-density polyethylene (LDPE), medium-density polyethylene (MDPE), high-density polyethylene (HDPE), polypropylene (PP), polyamides (PA), polycaprolactone (PCL), polylactic acid (PLA) polyvinyl alcohol (PVA), polyvinylidene fluoride (PVDF), crystalline polyethylene terephthalate (cPET), polybutylene terephthalate (PBT), polyhydroxyalkanoates (PHAs), and polybutylene succinate (PBS).

10. A 3D item (1) comprising 3D printed material wherein the 3D item (1) comprises a plurality of layers of 3D printed material, wherein the 3D item (1) comprises a stack of 3D printed layers, wherein:
the stack of 3D printed layers comprises n₁ first layers and n₂ second layers; wherein one of the n₁ first layers and one of the n₂ second layers are configured in contact with each other;
at least one first layer of the n₁ first layers has a higher first crystallinity than a second crystallinity of one or more of: (a) one or more optionally other n₁ first layers, and (b) the one of the second layers in contact with the one of the first layers.

11. The 3D item (1) according to claim 10, wherein the first subset of the layers has a first degree of crystallinity C₁ and a second subset of the layers has a second degree of crystallinity C₂, wherein C₁/C₂<0.9 or C₁/C₂>1.1.

12. A lighting device comprising the 3D item (1) according to claim 10, wherein the 3D item (1) is configured as one or more of (i) at least part of a lighting device housing, (ii) at least part of a wall of a lighting chamber, and (iii) an optical element.

13. A fused deposition modeling 3D printer configured to execute the method according to claim 1.

14. The fused deposition modeling 3D printer according to claim 13, wherein the printer comprises (a) a printer head comprising a printer nozzle and (b) a 3D printable material providing device configured to provide 3D printable material to the printer head, wherein the fused deposition modeling 3D printer is configured to provide said 3D printable material on a receiver item-(500); wherein the printer further comprises a gas blowing device configured to provide a flow of gas directed at least part of the 3D printed material, and (d) a control system, wherein the control system is configured to execute the method according to claim 10.
